(19) United States
(12) Patent Application Publication
(10) Pub. No.: US 2017/0213542 A1
(43) Pub. Date: Jul. 27, 2017

(54) SYSTEM AND METHOD FOR THE GENERATION OF EMOTION IN THE OUTPUT OF A TEXT TO SPEECH SYSTEM

(71) Applicant: James Spencer, Dublin, OH (US)

(72) Inventor: James Spencer, Dublin, OH (US)

(21) Appl. No.: 15/006,625

(22) Filed: Jan. 26, 2016

(51) Int. Cl. G10L 13/10; G10L 13/07; G10L 13/033; G10L 13/027

(52) U.S. Cl. CPC G10L 13/10; G10L 13/027; G10L 13/07; G10L 13/0335

(57) ABSTRACT

The present invention is a system and method for generating speech sounds that simulate natural emotional speech. Embodiments of the invention may utilize recorded keywords. Embodiments may also combine word sound segments to form words that are not available as recorded keywords. These keywords and word sounds may be selected using a word sound dictionary used during a text analysis process. Keywords and words formed from word sounds may be formed into sentences or phrases that comprise silent spaces between certain words and word sounds.

### CROSS-REFERENCE TO RELATED APPLICATION

This application is a nonprovisional patent application and makes no priority claim.

### TECHNICAL FIELD

Exemplary embodiments of the present invention relate generally to a text-to-speech system that produces true-to-life emotions in a generated digital audio output.

### BACKGROUND AND SUMMARY OF THE INVENTION

Text to speech generation technologies have existed for many years. Techniques for producing text to speech have included methods that identify words entered as text and assembling pre-recorded words into sentences for delivery to an output device such as an amplifier and speaker. Other methods comprise using prerecorded emotionless word segments that are processed together to form words, phrases and sentences. Another type of text to speech generation is performed entirely using computer generated sounds, without prerecording speech segments. As one skilled in the art will understand, the first method generally produces the most natural sounding speech but can be very limited in what sorts of phrases can be formed. One performance limitation of such a method is a less than smooth transition from one word sound to the next. The second method is capable of producing a greater variety of words and phrases but combining partial word sounds can result in disrupted sounding words and as a result, less natural sounding speech sounds. The last method has been used to produce almost limitless combinations of words but, because of the total use of computerized generation of the sound segments, suffers from the least natural sounding speech.

It is generally understood that a listener can recognize emotion in human speech, even if the level of emotion is minor. Similarly, a listener can also generally detect emotionless speech and recognize that it is generated by a machine. As a result, known methods of producing text to speech, which lack realistic emotional content, regardless of less of the method used to generate the speech, generally lack a level of realism that could be produced through the addition of an emotional component. As text to speech becomes more prevalent as the result of increasingly automated processes, the requirement for natural sounding speech becomes more urgent. What is needed is a means for producing a realistic text to speech output with an emotional component that further enhances the realism of the output speech.

In an embodiment of the invention, emotional speech may be formed using predetermined keywords (referred to herein as “rootkeys”), sound syllable segments (“HCSF”), sentence connector sounds (“SCON”s), and inflectors. Embodiments of the invention may include methods of scripting sentences and phrases, creating audio recordings of the sentence or phrase and using audio processing software programs or other methods to isolate sounds, and storing those sounds in one or more sound databases. In certain embodiments, predetermined keywords may be captured for later reuse in the formation of sentences or phrases. In certain embodiments of the invention, portions of words captured as sound syllables or sound segments may be combined to create a simulation of a spoken word that includes an emotional content. In embodiments of the invention, such syllables or sound segments may be combined using a word sound dictionary that comprises words and the sound syllables required to create each word. In certain embodiments of the invention, such sound syllables may be extracted from prerecorded word sounds by recording those words when spoken with a plurality of predetermined emotional expressions. In order to enhance the realism of generated speech sounds, certain embodiments of the invention may insert variable silent spaces between word sounds. These silent spaces may be generated by applying a constant to the word length preceding the space. Embodiments of the invention may vary the value of the constant used according to the emotion to be expressed by the generated speech sounds.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a block diagram of an embodiment of the invention;

FIG. 2 is a block diagram of a computer device used in an embodiment of the invention;

FIG. 3 is a flow chart illustrating an embodiment of the process used to capture rootkey word sounds;

FIG. 4 is a flow chart illustrating an embodiment of the process used to capture sentence connector word sounds;

FIG. 5 is a flow chart illustrating an embodiment of the process used to capture word segment sounds;

FIG. 6 is a flow chart illustrating an alternate embodiment of the process used to capture word segment sounds which include an emotional content;

FIG. 7 is a flow chart illustrating an embodiment of the invention in which word segment sounds are combined to form word sounds that comprise an emotional content;

FIG. 8 is a flow chart illustrating an embodiment of the invention in which rootkey, sentence connectors, word sounds comprised of word segment sounds, and inflection sounds are combined;

FIG. 9 is a flow chart illustrating an embodiment of the invention in which word sounds are combined with silent spaces to form a sentence or phrase with an emotional content; and

FIG. 10 is a flow chart illustrating an embodiment of the invention in which word sounds may be randomized.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

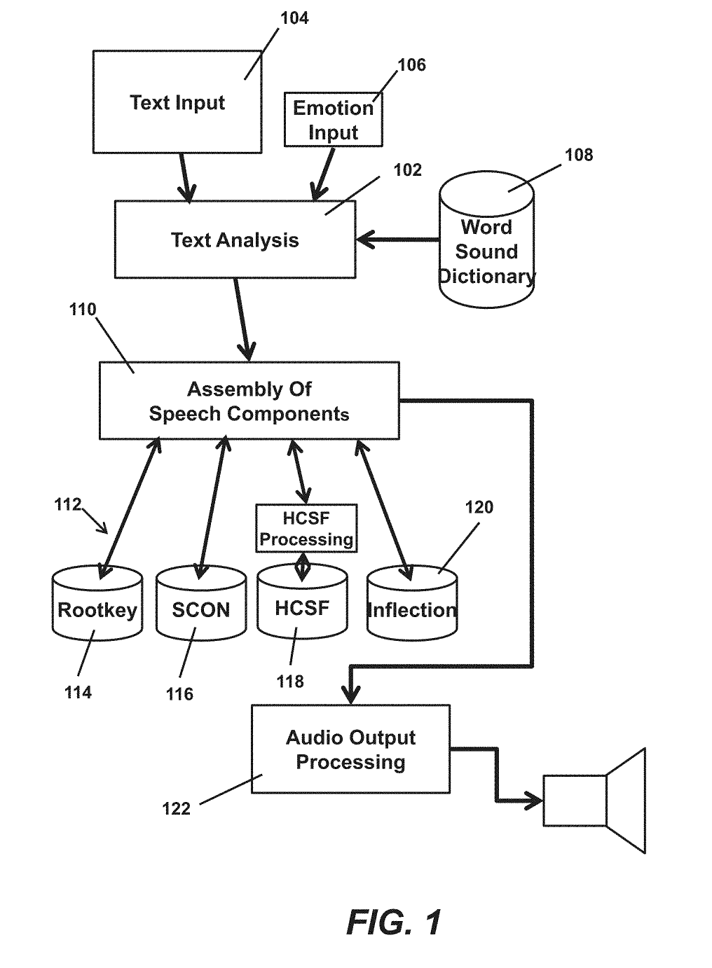

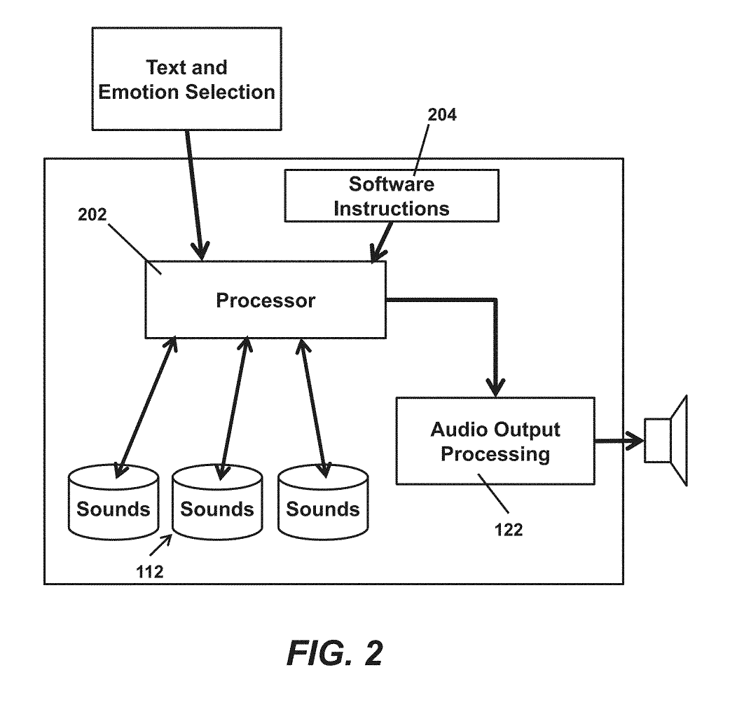

As illustrated in FIG. 1, a system for transforming text to speech with an emotional content may comprise an analysis function 102 that receives inputted text 104 and emotion selections 106. The analysis function may be in communication with a word sound dictionary 108 which comprises words and corresponding sound definitions. As will be described herein, each word may have a sound definition that designates sources of complete word sounds or word sound components. Using the sound definitions, an assembly function 110 may be used to retrieve the designated sounds from sound databases 112 and assemble those sounds into words and phrases. As will be described in more detail, the sound databases may comprise a rootkey word sound database 114, a sentence connector (SCON) sound database 116, an HCSF sound database 118, and an inflector sound database 120. The assembly function 110 may forward the words and phrases to an audio processing function 122 that combines the word sounds and any spaces and provides them to an amplifier or other audio output device. One ordinarily skilled in the art will realize that certain of these functions may be combined into one or more devices. In certain embodiments of the invention, one or more of the functions described above may be performed by a computerized device executing software instructions to perform the various steps described herein. For example, as illustrated in FIG. 2, a processor 202 may be configured to be in electronic communication with sound databases 112 and an audio processing device 122. In an embodiment of the invention, the processor may perform software instructions 204 to receive text input and emotion selections, process the received text and emotion selections, retrieve sounds from the databases, assemble the sounds into sentences or phrases that include an emotional content, and provide the assembled sounds to an audio processing function 112. These and other embodiments will now be described in greater detail.

### Rootkeys—Key Words

In an embodiment of the invention rootkeys are keywords recorded using scripted sentences designed to have one of a plurality of emotions, where each sentence may place the keyword into one of four positions. For example, in an embodiment of the invention, three emotions may be chosen: frantic, angry, and upset. Sentences may be scripted that position the key word into a sentence in one of the four positions where each sentence expresses the desired emotion. These three emotions are chosen to help the reader understand the concept described and should not be construed as limiting the invention to only the emotions referenced. Thus, embodiments of the invention may be used to generate speech having many different emotions.

The first keyword position will be referred to as the introductory keyword position. For example, if the chosen keyword is “car”, and the emotion being expressed is anger, an example of a scripted sentence with the keyword car in an introductory position may be “car won't start again!” In another example, the emotion representing the speaker feeling frantic is used and the keyword is “emergency.” For this example, a scripted sentence may be “emergency calls must be made.” As is illustrated, the introductory position is located at the very beginning of the scripted sentence.

The second keyword position may be referred to as the doorway keyword position. Words in this position generally, but not necessarily, fall at about the second word of a sentence structure. Using the emotion of anger and the keyword of “car”, a sentence such as “my car is a piece of junk” may be scripted. In another example, the emotion of frantic and the keyword of “emergency” may result in a scripted sentence of “this emergency is urgent!”

The third keyword position may be referred to as the highway keyword position. This reflects the word being positioned in a portion of the sentence in which the speech pattern of the speaker has left the introductory portion of a sentence and is moving through the body of the sentence. The highway keyword position may move depending upon the length of the sentence phrase. Using the previous emotion of anger and keyword of “car”, an example scripted sentence may be “I hate my car being towed.” Using the example of frantic and the keyword “emergency” may result in a scripted sentence of “I have an emergency happening.” As is illustrated, the keywords may vary slightly in their actual position within the sentence without departing from the inventive concept. In the above examples, the keyword in the first sentence was close to the middle of the sentence, having two words remaining in the sentence after the keyword, whereas the second sentence has the keyword positioned next to the last word in the sentence.

The fourth keyword position is the closing keyword position. This position is generally, but not necessarily, the last word in the sentence. Again, using the previous example words and emotions, a scripted sentence expressing anger and using the keyword “car” may be “I crashed my car!” A second example using the frantic emotion and the keyword “emergency” may be “this is an emergency!”

In an embodiment of the invention, a rootkey word library may be created by having a voice actor record scripted sentences for the selected keyword and emotion that placed the keyword into each of the four positions. Because keywords may be used to create the most natural sounding emotional speech content, a greater variety of keywords may result in a more robust and natural sounding speech from the invention.

Once the scripted sentences are recorded, the keywords may be isolated from the recorded sentence sounds using digital audio editing software such as Goldwave (Available from Goldwave Inc. www.goldwave.com). Each isolated keyword may be saved in a .WAV file and stored in a rootkey library. The process of isolating a word sound, or even a sound segment from a word, may be used to obtain the words and sounds used by embodiments of the invention to produce speech sounds. Those knowledgeable in the art frequently use the terms “cut”, “snip”, “trim”, “splice” and “isolate” to describe the process of capturing and saving sounds.

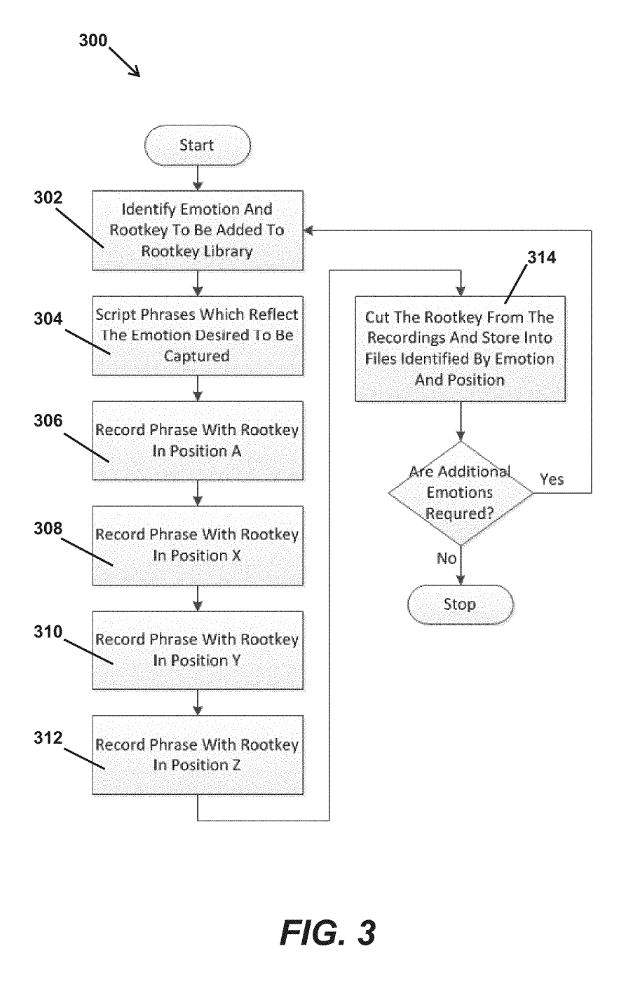

Scripted sentences should be comprised of sentences that fit the specific emotions that are desired to be captured. Best results may generally be achieved by scripting sentences which are appropriate for the emotion wishing to be captured to assist the voice actor in the accurate capture of the desired emotion. In certain embodiments, rootkey scripts may be generated using a fill-in-the-blank template sentence. For example, a sentence such as “I was hurt by your ______” and “you were ______ for doing that!” may be used to record keywords. An example of such a sentence may be “I was hurt by your girlfriend.” or “You were mean for saying that!” An example of the process of creating a rootkey word library is illustrated in the flowchart 300 of FIG. 3. As is shown, a rootkey word is selected in step 302. Sentences are scripted for each rootkey position and for each emotion desired 304. A voice actor then records each sentence 306, 308, 310, and 312. Digital audio editing software is used to cut the rootkey from the recording and store the recorded rootkey into a .WAV file identified by emotion and position 314. This process may be repeated until the desired rootkey words and emotions are stored in a rootkey library.

### SCON (Sentence Connector)

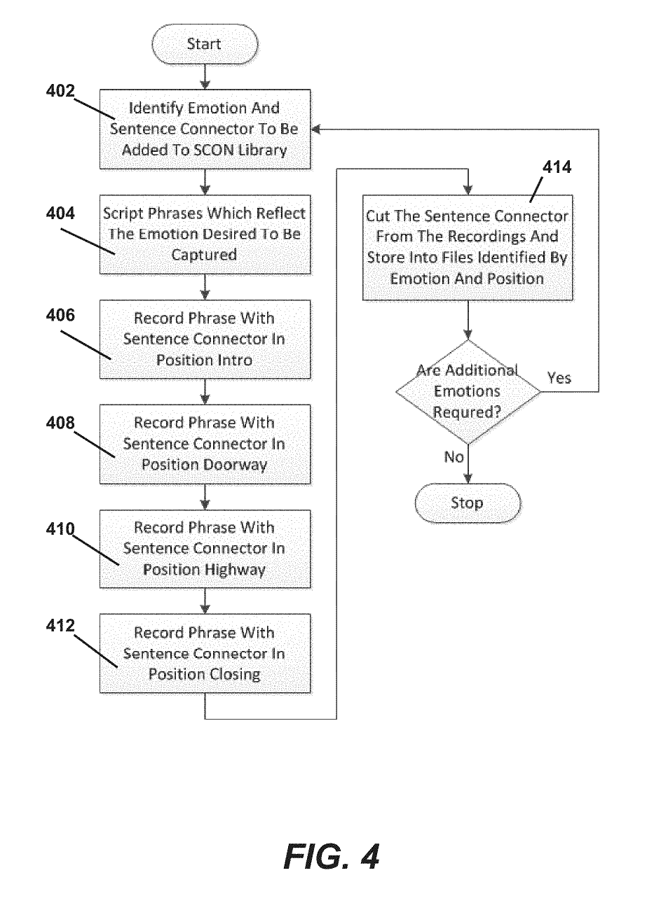

A similar technique may be used for a sentence connector (SCON). In embodiments of the invention, sentence connectors may comprise pronouns, auxiliary and linking verbs. Scripted sentences may be created for the desired emotion where the sentences locate the SCON in each of the four positions (introduction, doorway, highway, and closing). Referring to the flowchart of FIG. 4 which illustrates an embodiment of the invention, a SCON is selected for addition to the SCON library 402. Scripted phrases are developed which reflect the emotion desired to be added to the library 404. Scripted phrases may include a sentence which places the SCON in each of the four positions. A voice actor may then record each scripted sentence in steps 406, 408, 410, and 412. Sound editing software may be used to cut the SCON from the recording 414. In a manner similar used for rootkeys, the cut SCON may then be saved in a SCON library as a .WAV file identified by emotion and sentence position. In certain embodiments of the invention, in addition to those word types noted above, SCONs may also comprise conjunctions and articles.

### HCSF (Word Component)

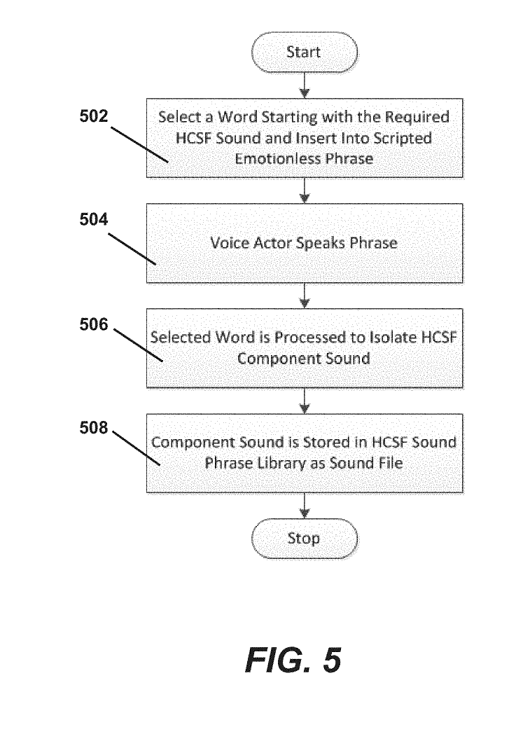

The methods described above allow for the capture of complete words in various sentence positions. As one ordinarily skilled in the art will realize, using complete words may result in the most ideal emotional sounding speech. However, recording a sufficient number of words to capture the majority of text entered for conversion into speech would take a tremendous amount of time and consume large amounts of memory in a computerized device which implements the methods described heretofore. In an embodiment of the invention, words not prerecorded as rootkeys or SCONs may be formed by combining word segments. Such segments may be recorded using a script that positions a word containing segments that are parsed out of the recorded word according to an alpha/beta/zeta/phi or inflection scheme. Referring to the flowchart of FIG. 5, using a pre-scripted sentence, a voice actor may record a word in step 502. As an example, the voice actor may speak the sentence “you are very unfriendly” 504. When recording a word for HCSF component parsing in an embodiment of the invention, the word is placed at the end of the scripted sentence. In this example, the word to be parsed is “unfriendly.” In step 506, the recorded word is parsed according into alpha, beta, zeta, phi, or inflection component sounds. Using the example of “unfriendly”, the parsed word segments may be “unn”, “frend”, and “ly”. As can be observed, these parsed segments are not necessarily syllables, but are instead the distinct sounds found in a word that is recorded. In this example, the “ly” sound is an inflector, the “unn” sound is an alpha sound and the “frend” is a beta sound. In step 508, these sounds are stored in .WAV files which are stored in a HCSF sound library. Unlike the rootkey and SCON scripting, sentences scripted for the purposes of recording words for HCSF parsing may not require an emotional component. In other words, while rootkey and SCON sentences are required to be scripted with an emotional content, for instance, anger, HCSF scripting is only required to result in the voice actor speaking the word as part of a sentence in order to ensure a natural pronunciation of the word.

HCSF word segments may be formed into spoken words using dictionaries of words that have related pronunciation tables referencing the segments needed to form the word. For example, the word “wondering” will have a pronunciation table that includes the word segment sounds of “wonn”, “durr”, and “ing.” These segments may be loaded into an output processing array which will be described later herein.

HCSF-2 (Word Component with Emotion)

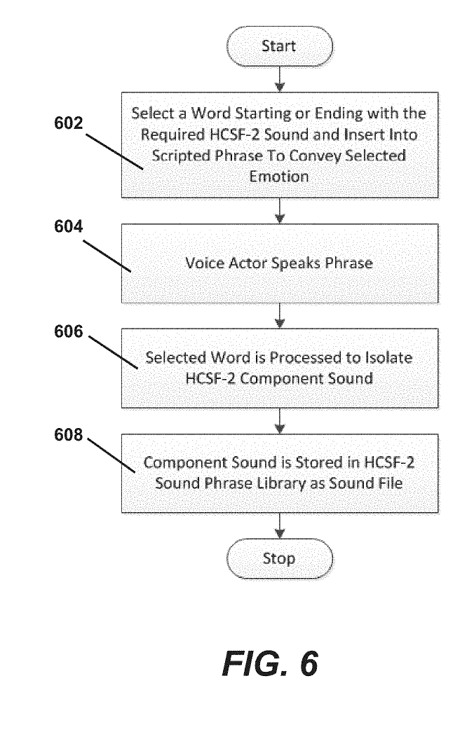

In addition to the HCSF method described above, a second HCSF format, the HCSF-2 format, may provide an emotional content rather than an emotionless word sound that may result from use of the HCSF method. Referring to the flow chart of FIG. 6, the HCSF-2 method uses words starting with the desired sound segment. These words are then placed in a pre-scripted phrase that conveys the emotion desired 602. For example, if the “wonn” sound is the desired sound segment, the word “wondering” may be used to produce that sound segment. As an example, if the desired emotion were anger, the sentence “I was wondering when you would get home” may be used. A voice actor may speak the phrase 604 that is used to produce a recording of the phrase and, as with the HCSF format described above. The recording may be processed in order to isolate the “wonn” portion 606 and that sound segment stored 608 for later use in a sound database comprised of HCSF-2 sound segments recorded for the various emotional states. Sound segments may be captured for sounds starting with each letter of the alphabet and stored in an HCSF or HCSF-2 sound library. For instance, for the letter “W”, a partial illustration of the sound recorded may comprise “wah”, “wheh”, “win”, and “wonn.” Other “W” sounds may be recorded as well as those sounds from A-Z in order to provide the most realistic word sounds that result from the assembly of those sounds as described below.

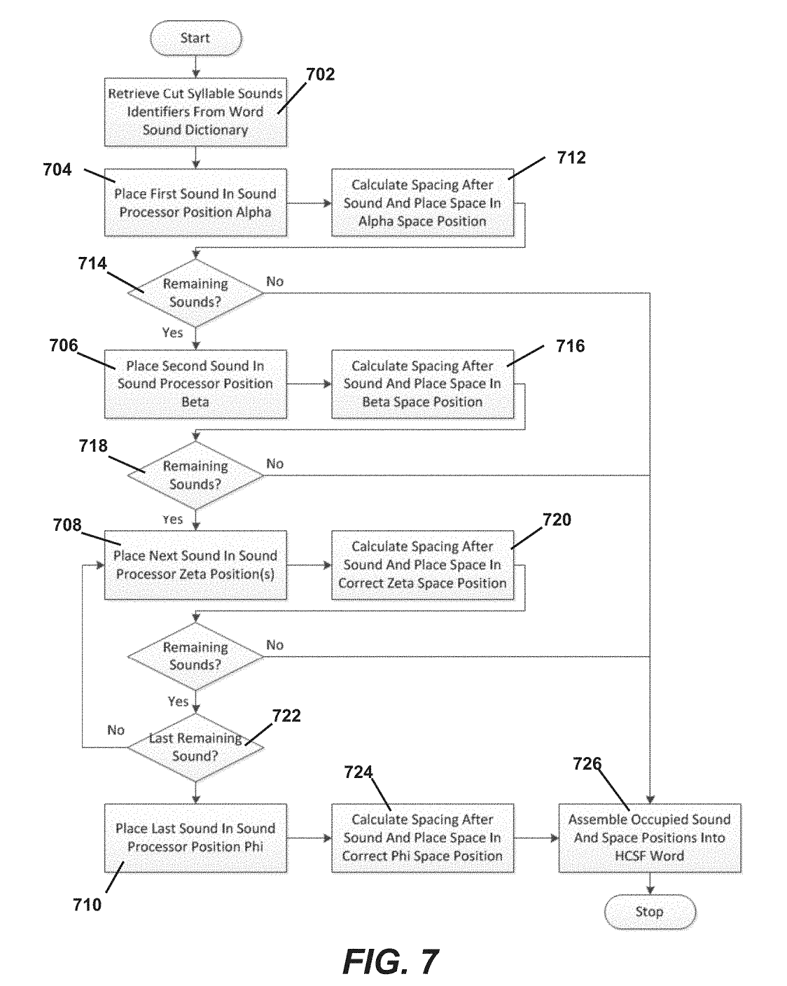

As was noted, the key difference between the HCSF and HCSF-2 formats is the addition of emotion. A word sound with an emotional content may be formed from HCSF-2 sound segments by combining those segments together to form the complete word sound. Referring to the flow chart of FIG. 7, the syllable sounds are identified from a word sound dictionary in step 702. As noted, the HCSF-2 format allows the incorporation of emotion and as a result, the syllable sounds retrieved using the HCSF-2 format are recorded using sentences that express the desired emotion. Once the syllable sounds required to form a word are identified in step 702, the first sound is retrieved and placed into an array of sounds in the first (alpha) position 704. It has been determined that proper emotional expression requires a small delay between each syllable sound used to form a word sound. This is calculated as a percentage of the length of the syllable sound, where the percentage varies depending upon the position of the syllable sound in the word formed as well as the emotion being expressed. For instance, as is illustrated in the flow chart of FIG. 7, sound positions may include alpha 704, beta 706, zeta 708, and phi 710. Each position may use a different percentage and the percentages used may vary from one emotion to another. As is illustrated, the delay spacing for the sound in the alpha position is calculated and stored in step 712. The process may check to determine if there are remaining sounds needed at 714. If there are sounds remaining in the word sound dictionary description of the word, the second sound is placed into the second sound position (the beta position) 706. The delay spacing is calculated and stored in step 716. The process checks again to determine if there are remaining sounds at 718. If there are sounds remaining, the processor retrieves the next syllable sound into a zeta position 708. A spacing is calculated at 720 and that spacing is stored. As will be noted, a forth position is described (the “phi” position). However, in order to accommodate words that may be comprised of more than four syllable sounds, the zeta position may be repeated until the next to last sound using the decision step 722. If the last syllable sound does not occur in the alpha, beta, or zeta position, the last syllable sound will be placed in the phi position in step 710. A spacing to be placed after the phi position syllable sound is calculated in step 724. Once the last syllable sound is placed and there are no additional sounds remaining, the sounds and spaces are assembled into a HCSF-2 word sound in step 726. As will be described herein, rootkey words, sentence connectors, inflections, inflectors, and HCSF/HCSF-2 words may be combined to form a phrase.

### Word Sound Dictionary

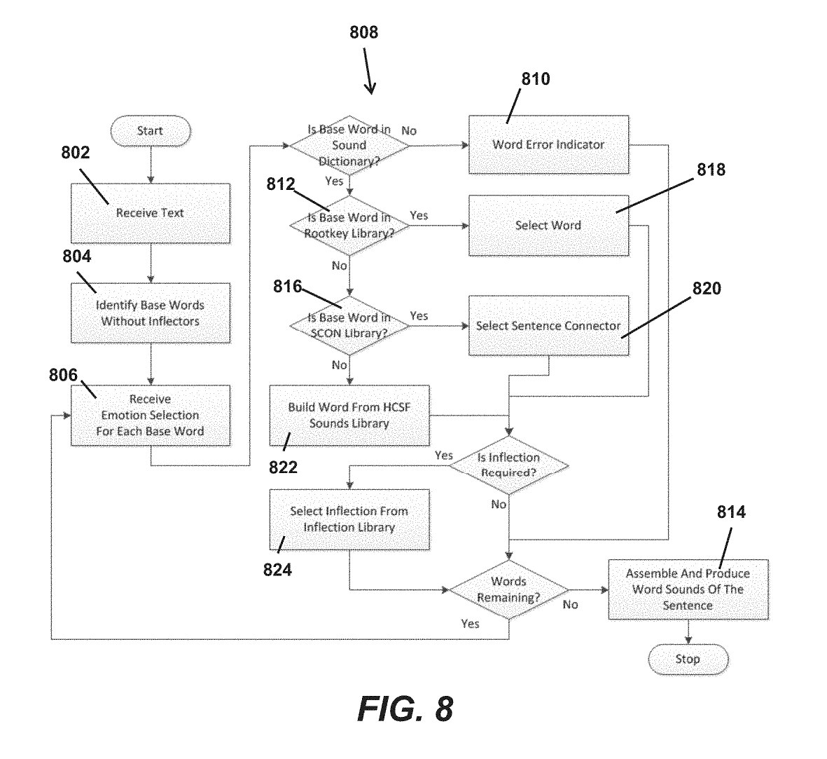

Now that the various rootkey words, sentence connectors, HCSF, HCSF-2 and inflection sounds have been detailed, the process of receiving a text phrase and breaking that phrase into each section will be described. A flow chart of an embodiment of the text to speech invention is illustrated in FIG. 8. In step 802, a text phrase is received. In step 804, the phrase may be analyzed and base words identified. As is illustrated, an emotion is received for each word in step 806. Allowing each word to have a different emotion may allow for more realistic speech as the emotional content may change as a sentence or phrase is spoken by a human speaker. With an identified word and emotion, an embodiment of the invention may search a word sound dictionary to identify the desired word 808. In order to enable an embodiment of the invention to process a phrase that contains a word not in the word sound dictionary, an error message or indicator may be generated in step 810. If the word is found in the dictionary, that word will have at least one sound definition. The sound definition is what certain embodiments of the invention use to produce the speech sounds associated with a word.

In an embodiment of the invention, a word sound dictionary may comprise a plurality of sound definitions for a given word, but those definitions may be accessed in an order intended to produce the most natural sounding emotional speech. In a preferred embodiment, this is in the order of rootkey sounds, sentence connector sounds, and HCSF sounds. Referring again to FIG. 8, an embodiment of the invention may search for a rootkey sound definition 812. If the word has a rootkey sound definition, that sound definition may be selected and, as will be described herein, the sound will be assembled with other word sounds 814 in order to produce the phrase that corresponds to the text and emotion entered in steps 802 and 806. If a rootkey sound definition is not found, or is not available in the selected emotion, an embodiment of the invention may search for a sentence connector sound definition 816. If a sentence connector sound definition is found for the word, the sentence connector word sound will be assembled with other word sounds 814 to produce the phrase that corresponds to the text and emotion entered in steps 802 and 806. As is noted at 818 and 820, rootkey and sentence connector sound definitions may identify a sound file corresponding to a complete recording of a word. Such recordings may be performed according to the methods described earlier herein. If a rootkey or sentence connector sound definition is not found in the word entry in the dictionary, an embodiment will search for a HCSF-2 sound definition. In step 822, a word sound may be assembled using the steps described in FIG. 7.

### Inflections

Referring to FIG. 8, step 824, after each word sound is identified or created, an embodiment of the invention may add inflection sounds as required by the received text. In certain embodiments of the invention, inflections are those sounds that end a word sound and may change the meaning or tense of the word to which they are added. Inflections are well known and include such extensions to a word as “ing”, “es”, “s”, and “ed.” Inflections may modify a word to express case, gender, tense, and singular vs. plural forms of a word. In embodiments of the invention, inflectors, those word ending sounds, may be recorded in a similar manner to HCSF-2 word sounds. An inflector may be identified and an emotion selected. For example, if the word without the inflector is “dance” and the inflector is “ing”, an embodiment of the invention may append the stored inflection sound to the identified word to create the sound “dancing.” Inflectors are word sounds that create the sound of a word after an inflection has been appended to that word. In an example embodiment of the invention, the inflection sound may be slightly different than the “ing” sound alone. Using the example of “dancing”, the word dance may be shortened to the sound “dan” and the inflector used may be “sing”. Such a combination may have a more natural sound than a combination of “dance” and “ing”. Therefore, in order to generate the most natural sounding speech, an embodiment of the invention may require several different inflector sounds be recorded for the “ing” inflection. Examples may include, but are not necessarily limited to, “bing”, “fing”, “ging”, “hing”, “jing”, “king”, “ling”, and so forth until “zing.” It should be noted that the inflector sounds may include a sound that represents the inflection upon which the inflector is based. In the cited example, the sound would be the “ing” sound without any additional sounds. Each of these “ing” inflectors may be recorded using scripts for the emotion desired. Other, non-“ing” inflectors may also require the addition of other sounds to the inflector sound in order to obtain the most natural sounding speech. An example may be the “ence” sound. Depending upon what word sound the “ence” inflector is added to, the inflector library may contain sounds such as “ence”, “dence” and “dance.” The determination of which inflector sounds to be used may be stored in the word sound dictionary and selected during the analysis process illustrated in step 824 of FIG. 8. In order to develop the required inflector sounds, a sentence script may be developed that contains a word that includes the inflector sound and that reflects the desired emotion. A voice actor may read a sentence script as the word containing the inflector sound is recorded. As with rootkey and sentence connector sounds, a digital audio editing software program such as Goldwave may be used to isolate the desired inflector sound and that sound may be stored as a sound file in an inflector library. Inflector sounds are added to word sounds with the addition of a small amount of silent space which may be calculated as a percentage of the word sound length. In certain embodiments of the invention this percentage may vary depending upon the emotion selected for the word. In certain embodiments of the invention, the “ing” inflector may be an exception to this spacing process. In such embodiments, the “ing” inflector or a variation thereof may be added to the word sound without a silent space.

### Jet-Array

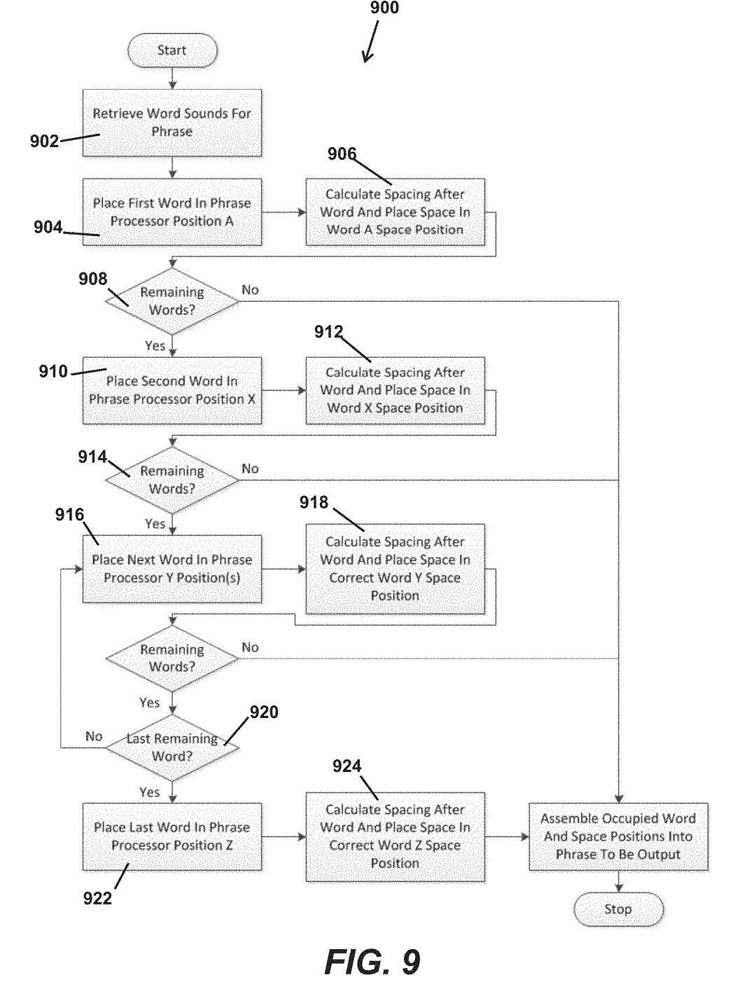

When the sounds for each word of a sentence or phrase have been identified or formed as described herein, the words may be assembled and converted to speech with emotional content. A flowchart of the process of sentence or phrase assembly 900 is illustrated in FIG. 9. In step 902, the word sounds are retrieved. After retrieval, the word sounds may be placed in an array structure which may have a plurality of word positions referred to herein as A, X, Y, and Z. Position Y may be repeated to accommodate longer sentences or phrases. In addition, such an array may also comprise positions for silent spaces that correspond to the word positions A, X, Y, and Z. As will be illustrated with the flow chart steps, embodiments of the invention may calculate a silent spacing for placement after each word position. In step 904, a first word may be placed into position A. In step 906, a silent space may be calculated for the word in position A. The silent space may be stored in the array to produce a slight amount of silence after the word sound is generated. This may have the effect of enhancing the natural sound of the speech. In order to calculate the proper silent space in an embodiment of the invention, the length of the word sound may be multiplied by a predetermined constant. In certain embodiments of the invention, that constant varies by the word position (A, X, Y, and Z). The constant may also vary based on the emotion to be conveyed by the word. For example, a first word sound may be 0.1 second with a silent spacing of 2.7 times the word sound length for an angry emotion. The second word may have a spacing of 3 times its sound length for an angry emotion. The third word may have a spacing of 3.25 times its length and so-on until each word sound is placed in the array along with its corresponding space. The same words with an emotion of happy may have silent spacing multipliers that are less than what was used for angry (for instance, 2.5, 2.7, and 3). Silent spacing multipliers that vary depending upon the word sound position and emotion may be key to the production of emotional sounding speech. As is illustrated in step 908, an embodiment of the invention may determine whether there are additional words to be placed in the array. If so, a second word sound may be placed in position X as shown in step 910. In step 912, the silent spacing is calculated and stored in the array after position X. In step 914, an embodiment of the invention may determine whether there are additional words and if so, place the next word sound into a first position Y in step 916. A silent space may be calculated in step 918 and stored in the array. Steps 916 and 918 may be repeated until the last word in the sentence or phrase. In certain embodiments of the invention, each successive iteration of step 918 may use a different silent spacing multiplier. When the last remaining word in the sentence or phrase is detected 920, that word may be placed in position Z 922. A silent space may be calculated in step 924. In certain embodiments, the silent space that corresponds to position Z may be a value that permits a silent space to continue until the next sentence is processed by an embodiment of the invention. In other embodiments, punctuation symbols may be received and processed by the invention to derive a predetermined silent space that corresponds to the different punctuation symbols received.

In certain embodiments of the invention, an emotion selection may be provided for each word by setting an emotion indicator or flag that corresponds to a word or words in a text sentence or phrase.

In certain embodiments of the invention, the array that comprises the words and silent spaces may be provided to a multi-channel audio output processor. Such embodiments may provide for improved quality in the speech output by using a first channel to process a word sound and silent spacing and a second channel to process the next word sound and associated silent spacing. The improvement may be the result of avoiding delays between the silent spacing following a word sound and the following word sound. Embodiments of the invention may also use this technique to process the sound segments and spaces that are combined to form word sounds using the HCSF and HCSF-2 methods as described herein.

### Speed of the Spoken Text

In addition to the text and emotion selections received by embodiments of the invention, some embodiments of the invention may also receive a factor that corresponds to the speed or pace at which the phrases are “spoken” by embodiments of the invention. Such factors may result in individual words or sounds being converted into speech that takes place over a shorter or longer time period to simulate a person speaking more slowly or more quickly. Adjustments may be made using known methods to adjust the pitch of word sounds to avoid excessively low or high intonation that may result from simply slowing or speeding up the rate at which a sound is reproduced. As was noted above, silent spacing is calculated based on the length of time that a sound takes to reproduce. Thus, a sound that has been slowed down according to such an embodiment may result in a correspondingly longer silent space. Conversely, speech that has been sped up may have silent spaces that are shorter than the same speech sounds produced at a normal rate or pace. Varying the silent spaces as described may result in the emotional content of the speech remaining intact while allowing the pace of speech to be sped up or slowed down as desired. In certain embodiments of the invention, the pacing may be varied for each word in a sentence or phrase. Varying the pace may allow a word or words to be emphasized in a manner similar to an actual speaker.

### Random Realization

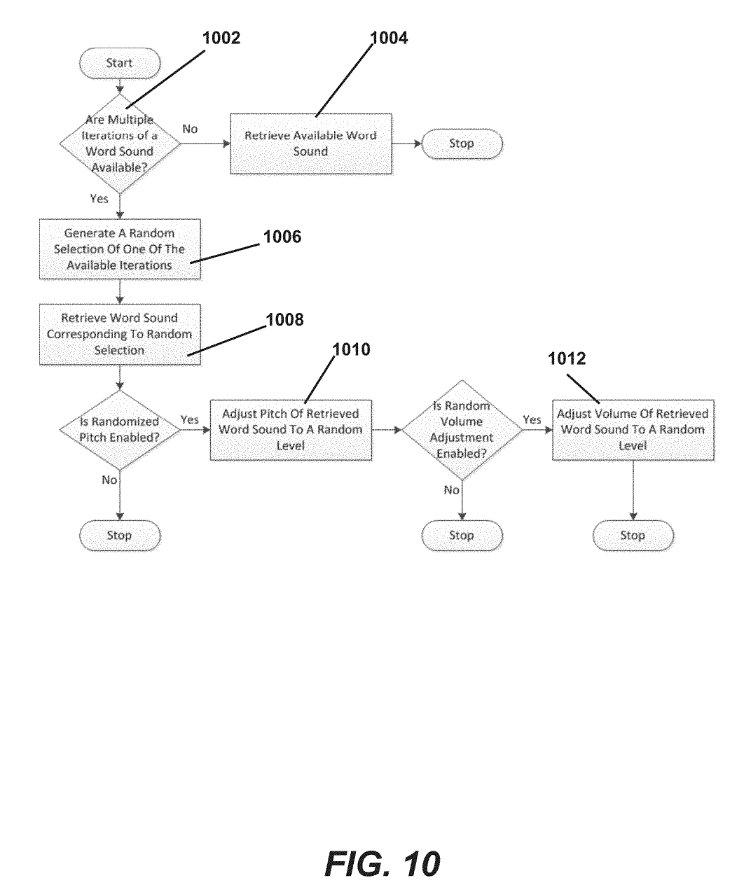

Certain embodiments of the invention may comprise sound randomizing functions that may serve to increase the level of realism obtained when converting text to speech. An embodiment of this type may randomly select from a plurality of word sounds available in a word sound library. A preferred embodiment may have 2-7 word sounds that correspond to a given word, HCSF, SCON, inflector, or other word sound identified by the word sound dictionary. Such sounds may be captured and stored according the processes described herein. Certain embodiments may capture such sounds by repeating the same script for each capture and storage instance. Other embodiments may utilize more than one script to provide additional variation between the plurality of word sounds. Embodiments of the invention that implement a sound randomizing functions may randomly select from the available word sounds when the word sound dictionary definition indicates that a word sound is required to produce emotional speech. Referring to FIG. 10, in step 1002, an embodiment of the invention may determine whether there are a plurality of word sounds as described herein. If such a plurality of words sounds are not available in the word sound database, the word sound that is available may be selected 1004. If there are a plurality of word sounds available, the function may generate a random selection of the available sounds 1006 and the selected sound may be retrieved from a word sound library or database 1008.

In addition to selection from a plurality of word sounds, certain embodiments may also adjust the pitch of the retrieved word sound. In step 1010, such an embodiment may randomly select an adjustment and apply it to the word sound. Preferred embodiments may limit the range of randomization to plus or minus 5.25%. Certain other embodiments may select a more limited range, for example, plus or minus 2.5%.

In addition to randomized selection of word sounds and adjustments to pitch, certain embodiments may also adjust the volume of certain word sounds to further enhance the realism of the speech produced by the embodiment of the invention. As is illustrated in step 1012 of FIG. 10, the sound randomizing function may determine whether random volume adjustment has been enabled. If so, such an embodiment of the invention may randomly adjust the volume level of the word sound. As with the random pitch adjustment, preferred embodiments of the invention may limit the amount of adjustment available. In such an embodiment, a volume adjustment may be limited to plus or minus 35%. Certain other embodiments may limit the volume adjustment range to plus or minus 10%. In order to optimize the random nature of the sound randomizing function, embodiments of the invention may return the pitch and volume levels back to the default level after adjusting each word sound in order to prevent changes from accumulating to result in unnatural sounding speech.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. For clarity, only certain selected aspects of the software-based implementation are described. Other details that are well known in the art are omitted. It should be understood that the disclosed technology is not limited to any specific computer language or program. For example, the disclosed technology may be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this description. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of electronically generating speech with an emotional inflection from text comprising the steps of:
receiving text input representing word sounds to be formed;
receiving an emotion to be portrayed by the received text input;
analyzing the received text to identify word sounds to be formed;
retrieving, from a word sound library, word sounds comprising at least one of: a rootkey, a sentence connector, a sound syllable segment, or an inflection from a word sounds database where such sounds are retrieved according to a predetermined preference and the received emotion; and
combining the word sounds into a speech phrase representing the received text input.

2. The method of claim 1, wherein the step of receiving word sounds also comprises a sound syllable segment with an emotional content.

3. The method of claim 1, wherein the step of analyzing the received text comprises the sub steps of:
identifying base words;
receiving an emotion selection for each word; and
for each base word, searching a word sounds database for at least one of a base word in a sound dictionary, a base word in a rootkey library, a base word in a sentence connector library, or building the base word from sound syllable segments.

4. The method of claim 3, additionally comprising the step of determining if an inflection is required for the base word.

5. The method of claim 3, where the step of combining the word sounds into a speech phrase comprises combining sound syllable segments into word sounds which comprises the sub steps of:
retrieving a sound syllable segment for a word sound;
calculating a spacing to follow the sound syllable segment;
determining if there are remaining sound syllable segments required to form the word sound;
retrieving any remaining sound syllable segments for the word sound; and
calculating a spacing to follow each of the remaining sound syllable segments.

6. The method of claim 1 wherein the step of combining the word sounds into a speech phrase comprises the sub steps of:
placing a first word sound in a first phrase position;
calculating a first time spacing;
placing the calculated first time spacing in a second phrase position;
placing a second word sound in a third phrase position;
calculating a second time spacing;
placing the calculated second time spacing in a fourth phrase position; and
placing any remaining word sounds of the speech phrase into subsequent phrase positions followed by calculated time spacing in the phrase positions immediately after each remaining word sound.

7. The method of claim 6, wherein the step of calculating time spacings are formed by multiplying the time representing the total time of the word sounds of a word and multiplying the result by a predetermined constant.

8. The method of claim 7, wherein the predetermined constant varies according to the phrase position of the word in the phrase position immediately prior to the phrase position in which the time spacing is to be stored.

9. The method of claim 1, wherein the step of retrieving, from a word sound library, word sounds comprises the additional step of determining if there are multiple instances of a word sound in the library and when multiple instances are present, randomly selecting from the available word sounds.

10. The method of claim 1, wherein a pitch of the retrieved word sound is randomly adjusted to a level between an upper and lower predetermined pitch level.

11. The method of claim 1, wherein a volume level of the retrieved word sounds is randomly adjusted to a level between an upper and lower predetermined volume level.

12. A method of producing word sounds for use in the word sound library of claim 1, comprising the steps of:
receiving an emotion identifier;
generating a script which places a word sound in a first position;
recording, in a first recording, a person speaking the generated script which places the word sound in the first position;
isolating the word sound from the first recording and storing the word sound in the word sound library;
generating a script which places a word sound in a second position;
recording, in a second recording a person speaking the generated script which places the word sound in the second position;
isolating the word sound from the second recording and storing the word sound in the word sound library;
generating a script which places a word sound in a third position;
recording, in a second recording a person speaking the generated script which places the word sound in the third position;
isolating the word sound from the third recording and storing the word sound in the word sound library;
generating a script which places a word sound in a fourth position;
recording, in a second recording a person speaking the generated script which places the word sound in the fourth position; and
isolating the word sound from the forth recording and storing the word sound in the word sound library.

13. The method of claim 12, where the word sound is a rootkey sound.

14. The method of claim 12, where the word sound is a sentence connector sound.

15. A method of producing a sound syllable segment for use in the word sound library of claim 1, comprising the steps of:
receiving an emotion identifier;
identifying a first word in which the sound syllable segment is located in a position of the word;
generating a script which contains the identified first word;
recording a person speaking the script using the emotion identifier;
isolating the sound syllable segment from the recording; and
storing the isolated word sound in the word sound library.

16. The method of claim 15, wherein the emotion identifier represents emotionless speech and the position in which the sound syllable segment is located is a start of the word.

17. The method of claim 15, wherein the position in which the sound syllable segment is located is the start of the word and comprising the additional steps of:
identifying a second word in which the sound syllable segment is located in a position of the word which is located at an end of the word;
generating a script which contains the identified second word;
recording a person speaking the script using the emotion identifier;
isolating the sound syllable segment from the recording; and
storing the isolated word sound in the word sound library.
